(19) United States
(12) Patent Application Publication
(10) Pub. No.: US 2010/0123024 A1
(43) Pub. Date: May 20, 2010

(54) AIR CAP WITH AIR DIRECTOR

(75) Inventors: Alfred GÖHRING, Salem (DE); Peter Ibele, Horgenzell (DE); Hermann Probst, Ravensburg (DE)

Correspondence Address: BURR & BROWN, PO BOX 7068, SYRACUSE, NY, 13261-7068, US

(73) Assignee: J. Wagner GmbH, Markdorf (DE)

(21) Appl. No.: 12/620,694

(22) Filed: Nov. 18, 2009

(30) Foreign Application Priority Data
Nov. 19, 2008 (EP) 08 020 164.3

(51) Int. Cl. B05B 1/28; B23P 17/04; B29C 45/00

(52) U.S. Cl. 239/291; 29/428; 264/328.1

(57) ABSTRACT

An air cap for generating an air stream by means of an atomized liquid is proposed, the liquid being atomized via a liquid nozzle, preferably with a needle valve, in the region of an air outlet orifice of the air cap, and the air cap comprising at least one further air outlet orifice which is connected to at least one following air director and which generates a directed air jet. According to the invention, the air director is produced, in particular formed, as a separate element and is connectable to the air cap.

This application claims the benefit under 35 USC §119(a)-(d) of European Application No. 08 020 164.3 filed Nov. 19, 2008, the entirety of which is incorporated herein by reference.

### FIELD OF THE INVENTION

The invention relates to an air cap for generating an air stream by means of an atomized liquid.

### BACKGROUND OF THE INVENTION

Liquids, especially paints for the coating and protection of surfaces, are applied to a surface in a known way by means of spray guns. Such spray guns for atomizing a liquid paint are known in a multiplicity of different embodiments.

For an effective homogeneous application of paint to a surface, an important criterion for use is in this case the exploitable range of paint jet geometry. A preferred paint jet geometry for surface treatment is, for example, a flat jet form.

The publication EP 1 880 771 A1 shows a spray gun for the spraying of paints, a union nut arranging an air cap, having two air directors (air horns) arranged diametrically opposite one another, in front of a gated disk. Air ducts are incorporated in the air directors and direct an air stream laterally onto a paint jet emerging from the spray gun, with the result that the geometry of the paint jet form is changed.

The housing components required for this purpose, and also the air-conveying and paint-conveying components of the spray gun, such as, for example, the paint nozzle with needle valve, the gated disk or the air cap with the air directors, are usually produced by the injection molding method, the air cap being produced materially in one piece with the air directors.

To produce an air cap materially in one piece with air directors, complicated and cost-intensive injection molds are required in order to fulfill the usually stringent requirements with regard to form geometry or surface quality of such components.

Furthermore, the freedom of configuration, especially in the region of the air duct routing in the air horns, is restricted, because, to produce injection moldings materially in one piece with complicated air duct routing, an injection mold of likewise complicated form is required or even further treatment steps, such as, for example, drilling operations, are necessary.

For this reason, an object of the invention is to avoid the known disadvantages of the prior art and to develop the production of an air cap with air directors in a flexible and efficient way.

### SUMMARY OF THE INVENTION

The invention proceeds from an air cap for generating an air stream by means of an atomized liquid, the liquid being atomized via a liquid nozzle, preferably with a needle valve, in the region of an air outlet orifice of the air cap, and the air cap comprises at least one air outlet orifice which is connected to at least one following air director and which generates a directed air jet.

The form of the emerging atomized liquid jet can be varied by means of an air jet emerging from the air director.

A main point of the invention is that the air director is produced, in particular formed, as a separate element and is connectable to the air cap.

The advantage of this is that an injection mold required for forming a separate air director can have a simpler geometry, especially for spatial geometries, such as, for example, an air duct, located in the component.

It is additionally advantageous that the air director can be exchanged in a simple way as a separately produced element, without changes to the air cap having to be carried out.

In a preferred embodiment of the invention, there is provision for the air director to be attachable to the surface of the air cap by connection means, for example a sliding guide.

Such connecting elements, for example dovetail guides or tongue-and-groove back-fitting structures, can be formed in a simple way particularly by the injection molding method.

In another embodiment of the invention, there is provision for the air director to be capable of being pushed in through an orifice in the air cap.

The advantage of this is that the connecting element on the air director and on the air cap can have a structurally simple design, for example with a peripheral conical collar rim which bears on the rear side of the air cap. Furthermore, in a further refinement of the invention, there is provision for the connection mechanism of the air director to make a positive, preferably latching connection with the air cap.

A positive, preferably latching connection of the air director to the air cap has the advantage that the air director can be fixed on the surface of the air cap in such a way that an undesirable displacement or a loss of the air director is avoided when the paint spray gun is in operation.

Moreover, in a further embodiment of the invention, there is provision for the air director to have at least one air duct.

The advantage of forming an air director together with an air duct is that, for example, the air stream which impinges in order to form a flat paint jet generates a reduced spread, for example in comparison with a deflection plate, with the result that an exact alignment of the air stream with the paint jet and the resulting forming of the paint jet become possible.

Furthermore, in a preferred refinement of the invention, there is provision for the connection mechanism of the air director to produce a coding.

Depending on the design of the connection mechanism in terms of its form, an associated receptacle in the air cap can be adapted in such a way that this can receive only an associated connecting element coded to the receptacle and therefore a defined air director.

This avoids an undesirable confusion between differently designed air directors on an air cap, for example during attachment by the final consumer.

In a further preferred embodiment of the invention, there is provision for the air director to be designed as a foldable injection-molded element, the individual molded halves of which are connected to one another by means of a film hinge.

The advantage of forming an air director with individual molded halves is that the production of such an air director by injection molding can be appreciably simplified. For example, the run of an air duct in the air director is shifted from its spatial arrangement in the assembled air director into one plane for simplified production by the injection molding method.

In a further preferred embodiment of the invention, there is provision for the air duct in the air director to have a defined surface roughness.

Thus, for example, it is advantageous if the inner surface of the air duct has successive half-round depressions (golf ball principle) in order to improve the flow properties of the air flowing through.

Moreover, in a further embodiment of the invention, there is provision for the air duct in the air director to be formed continuously, free of edges.

An air stream flowing through the air duct may, due to edges or sudden changes in direction, generate turbulences, be dammed up or become too weak. This is avoided by means of an appropriate uniform duct run.

Moreover, it is conceivable that the air director formed by means of a film hinge can be formed, connected in one piece together with the air cap, by means of a further film hinge.

The advantage of this is that the production costs for forming two interconnected components can be lowered, since only a single injection mold needs to be used for the complete element (air cap and air director).

Furthermore, the film hinge arranged between the air director and the air cap gives rise to an anti-loss and confusion-proof overall component for a spray gun.

In addition, the invention proceeds from a method for producing an air cap which is connected to at least one following air director and which generates a directed formed air jet.

The essence of this method is that at least one air director is formed as a separate element and is arranged on the surface of an air cap by means of a connection means.

In a further preferred refinement of the method, there is provision for the air director to be produced in one piece with the air cap.

Moreover, in a further preferred refinement of the method, there is provision for the air director and/or the air cap to be produced by the injection molding method.

Forming an air director and/or an air cap by the injection molding method has the advantage that such elements having a complex shape can be produced efficiently in a single work step.

### BRIEF DESCRIPTION OF THE DRAWINGS

Further features of the invention may be gathered from the following figure description and the drawing in which:

FIG. 1 shows a spray gun for liquids which is known from the prior art;

FIG. 2 shows an air cap known from the prior art, with air directors formed on in one piece and a union nut;

FIG. 3 shows a gated disk known from the prior art for air distribution for an air cap;

FIG. 4 shows an air director formed from two molded halves;

FIG. 5 shows a part view of an air cap with a coded receptacle for an air director; and

FIG. 6 shows an air cap in a view from below.

### DETAILED DESCRIPTION OF THE INVENTION

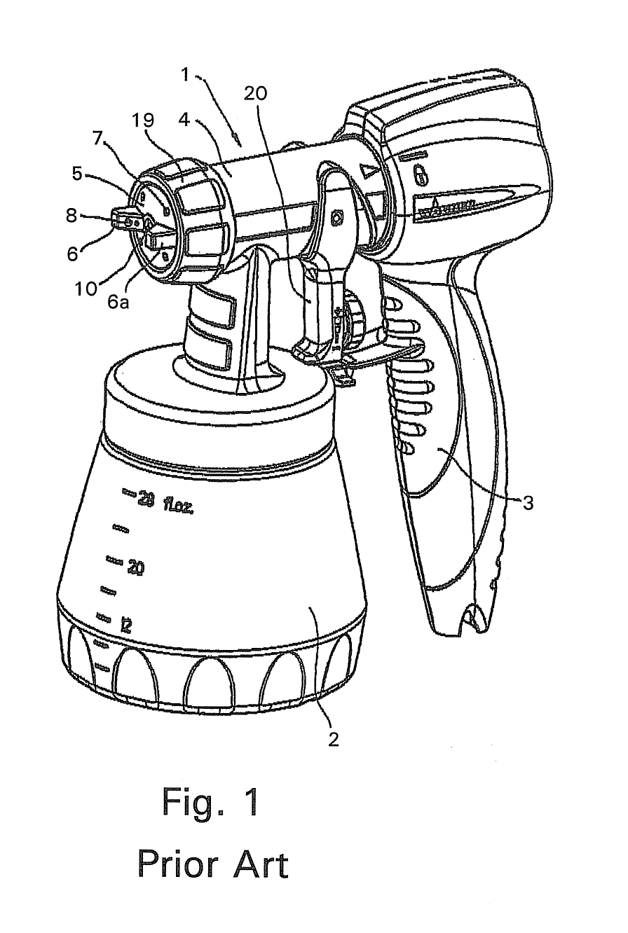

FIG. 1 shows a conventional spray gun 1 for liquids, preferably for paints, which has a liquid container 2, a handle element 3 and, at the front end of a gun housing 4, an air cap 5 with air directors 6, 6a arranged in one piece on the latter, the air cap 5 being held on the gun housing 4 by means of a union nut 19.

When the spray gun 1 is in operation, a liquid paint emerges from a paint nozzle 12 (illustrated in FIG. 3) as a result of the actuation of a pull lever 20 and is atomized in the region of a central recess 10 of the air cap 5 by means of outflowing air, the air being supplied continuously to the spray gun 1.

An atomized paint jet has preferentially a circular surface geometry when no air directors 6 are present.

The air cap 5 is designed, on its outwardly directed surface, with two air directors 6, 6a which are arranged diametrically opposite one another and are connected in one piece to the air cap and through each of which an air duct 8 passes.

An air stream emerging from the annular gap formed by the central recess 10 and the paint nozzle 12 generates, together with the emerging paint, an atomized paint jet, the latter being shaped from a conical spatial geometry into a virtually linear flat jet by the laterally impinging air flow coming from the air directors 6, 6a.

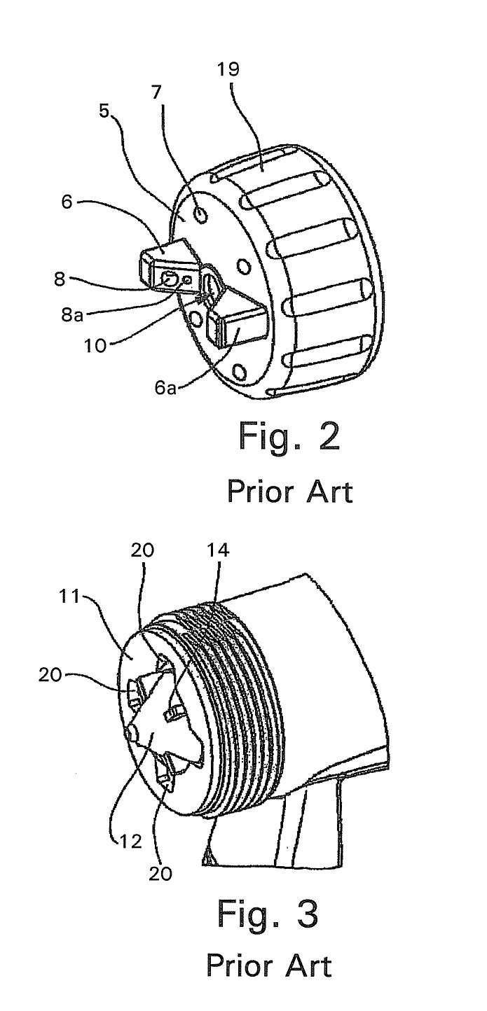

FIG. 2 shows an air cap 5 known from the prior art with a union nut 19, the air cap 5 having a central recess 10 through which the air supplied flows.

The air directors 6, 6a formed in one piece on the surface of the air cap 5 each have an air duct 8 directed onto the atomized paint jet.

A further embodiment illustrates, for example, the arrangement of two air ducts 8, 8a lying one above the other in an air director 6, 6a, these converging, for example, in one common duct in the air director 6, 6a or having air flowing through them in separate ducts.

FIG. 3 shows a gated disk 11 which has a central recess with orifices 20 directed radially outward and through which the paint nozzle 12 partially penetrates.

The orifices 20 cooperate, for example, with the compensating orifices 7 and give rise to what is known as a “round jet operation” of the paint spray gun 1. By the air cap 5 being rotated, the orifices 20 are brought opposite to the air ducts 8, 8a of the air directors 6, 6a, with the result that the compensating orifices 7 on the air cap 5 are inoperative and what is known as a “flat jet operation” of the paint spray gun 1 is formed.

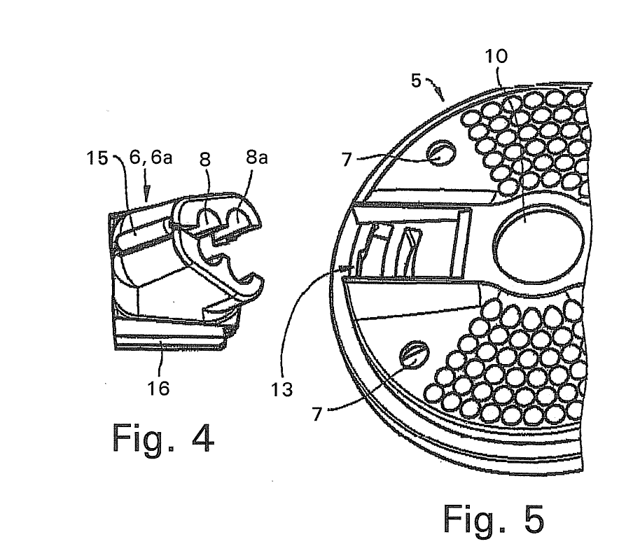

FIG. 4 shows an air director 6 or 6a according to the invention which is formed from two molded halves which are connected to one another by means of a film hinge 15.

In the lower region, the air director 6, 6a has a connecting element 16 which is designed, for example, as a sliding guide and which can be pushed into a correspondingly coded receptacle of air passage orifices 13 (illustrated in FIG. 5) on the air cap 5.

On an obliquely downwardly directed surface of the air director 6, 6a, the latter has at least one air duct 8 for forming a flat jet.

The air director 6, 6a is formed by the injection molding method, the spatial geometry of the air ducts 8, 8a being shifted into one plane by the air director according to the invention being formed in two molded halves as a folding part by means of a film hinge.

FIG. 5 shows an air cap 5 according to the invention, this comprising a central recess 10 through which the air supplied flows.

On a surface position lying radially outward, the air cap 5 has an air passage orifice 13 which is designed for a coded reception of the air director 6, 6a, via the connecting element 16.

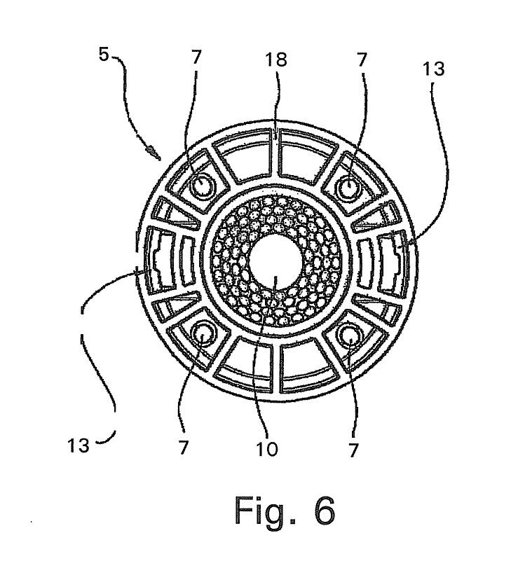

FIG. 6 shows an air cap 5 from below, this being subdivided on its rear side into individual portions by webs 18 formed on radially outward.

The compensating orifices 7 and the air passage orifice 13 for the air directors 6, 6a are arranged in the portions.

In the present embodiment, the air director 6, 6a is designed with a sliding guide as a connecting element 16, the air director 6, 6a and the air cap 5 being formed as separate components which have to be assembled and, where appropriate, latched together before proper use.

In this case, a separate arrangement which, for example, involves the forming of the air director and the forming of the air cap within one injection mold can be implemented in order to lower the production costs.

The subject of the present invention arises not only from the subject matter of the individual patent claims, but also from the combination of the individual patent claims with one another.

All the particulars and features disclosed in the documents, including the abstract, in particular the spatial design illustrated in the drawings, are claimed as essential to the invention, insofar as they are novel with respect to the prior art individually or in combination.

### List of Reference Symbols:

1 Paint spray gun

2 Paint container

3 Handle element

4 Gun housing

5 Air cap

6 Air director

6a Air director

7 Compensating orifice (air)

8, 8a Air duct

10 Central recess

11 Gated disk

12 Paint nozzle (liquid nozzle)

13 Air passage orifice

14 Connecting web

15 Film hinge

16 Connecting element

19 Union nut

20 Pull lever

We claim:

1. An air cap for generating an air stream by means of an atomized liquid, the liquid being atomized via a liquid nozzle in the region of an air outlet orifice of the air cap, the air cap comprising at least one further air outlet orifice which is connected to at least one following air director and which generates a directed air jet, wherein the air director is formed as a separate element and is connectable to the air cap.

2. An air cap according to claim 1, wherein the air director is attachable to the surface of the air cap by a connection mechanism.

3. An air cap according to claim 2, wherein the connection mechanism is a sliding guide.

4. An air cap according to claim 1, wherein the air director is pushed in through a recess in the air cap.

5. An air cap according to claim 2, wherein the connection mechanism makes a positive connection with the air cap.

6. An air cap according to claim 5, wherein the positive connection is a latching connection.

7. An air cap according to claim 1, wherein the air director has at least one air duct.

8. An air cap according to claim 2, wherein the connection mechanism produces a coding.

9. An air cap according to claim 1, wherein the air director is a foldable injection-molded element, the individual molded halves of which are connected to one another by a film hinge.

10. An air cap according to claim 1, wherein the air director has an air duct with a defined surface roughness.

11. An air cap according to claim 10, wherein the air duct is formed continuously, free of edges.

12. An air cap according to claim 1, wherein the air director is attached to the surface of the air cap symmetrically with respect to another air director, and each air director has an air duct with an air outlet orifice that is directed onto the atomized liquid.

13. An air cap for generating an air stream by means of an atomized liquid, the liquid being atomized via a liquid nozzle in the region of an air outlet orifice of the air cap, the air cap comprising at least one further air outlet orifice which is connected to at least one following air director and which generates a directed air jet, wherein the air director formed by means of a film hinge is produced in one piece together with the air cap by means of a further film hinge.

14. A method for producing an air cap with air directors arranged on it, according to claim 1, wherein at least one air director is formed as a separate element and is arranged on the surface of the air cap by means of a connecting element.

15. A method according to claim 14, wherein the air director is produced in one piece with the air cap.

16. A method according to claim 14, wherein at least one of the air director and the air cap is produced by an injection molding method.
